(19) United States
(12) Patent Application Publication
(10) Pub. No.: US 2006/0000497 A1
(43) Pub. Date: Jan. 5, 2006

(54) Clean hands paint roller washer system

(76) Inventors: Bruce R. Searle, Rainier, WA (US); Alexander L. Anderson, Rainier, WA (US)

Correspondence Address: Alexander L. Anderson, 17049 Reichel Rd., S.E., Rainier, WA, 98576, US

(21) Appl. No.: 11/158,192

(22) Filed: Jun. 22, 2005

Related U.S. Application Data
(60) Provisional application No. 60/581,388, filed on Jun. 22, 2004.

(51) Int. Cl. B08B 3/00

(52) U.S. Cl. 134/137

(57) ABSTRACT

A paint roller frame with a paint roller is held firmly by an adjustable holding device affixed externally to a containment cylinder. The containment cylinder contains a high pressure spray jet system designed to apply a series of close centered liquid jets which impinge along the length of the paint roller nap and at a controlled angle to the nap thus providing nap washing conditions that rotate the paint filled nap fast enough to create centrifugal force to the paint on and in the nap and a forceful spray jet which will wash away the paint particles. To provide superior nap washing conditions the direction of rotation of the nap can be changed by simply changing the spray jet angle of attack on to the nap and so allow the roller to rotate in the opposite direction for maximum cleaning benefit. The bracket assemble, which holds the paint roller frame, is specifically designed to accommodate all sizes of paint roller diameters and also the dimensional variations found in the proprietary paint roller frames. This factor alone makes it truly versatile. No hands need touch the paint roller until after the paint roller is thoroughly washed. Costly throw away paint roller mind set can be altered by this simple and practical apparatus. It is to be considered a tool by all who use it.

### REFERENCES CITED

| | | | |
|---|---|---|---|
| 2,938,368 | May 1960 | Bixel | 134/900X |
| 3,133,548 | May 1964 | Carr | 134/138 |
| 3,139,891 | July 1964 | Faustman | 134/900X |
| 3,422,828 | January 1969 | Dommer | 134/900X |
| 3,428,060 | February 1969 | Spivey | 134/900X |
| 3,587,599 | June 1971 | Bywater | 134/900X |
| 3,748,683 | July 1973 | Smith et. Al | 15/248.2 |
| 3,942,205 | March 1976 | Walls | 15/248.2X |
| 4,254,529 | March 1981 | Cooke | 15/248.2X |
| 4,569,099 | February 1986 | Harding | 134/900X |
| 4,733,679 | March 1988 | Dolcater | 134/900X |
| 4,832,066 | May 1989 | Shipman | 134.900X |
| 5,409,027 | April 1995 | Glunt | 134/900X |
| 5,626,158 | May 1997 | Gratopp | 134/900X |
| 6,019,111 | February 2000 | Gillies | 134/900 |
| 6,363,954 B2 | April 2002 | Bastien | 134/900 |
| 6,408/862 B1 | June 2002 | Rooyen | 134/138X |
| 6,450,185 B1 | September 2002 | Sallinen | 134/900X |

### FIELD OF THE INVENTION

The present invention relates generally to the washing of paint from a paint roller and more specifically to hands that never necessarily touch the paint roller and an adjustable liquid spray jet system and paint holder clamping system which allows for rollers of different diameters, nap densities, and paint roller frame variable sizes.

### DESCRIPTION OF THE RELATED ART

It can be appreciated that paint roller washing apparatus, over the years have, as yet, not reached the market place. It can be seen that related art patents, going back at least twenty years, have been cumbersome, bulky, not practical, hand contact being made with paint on the roller, have a fixed fluid jet angle to clean naps of various diameters and densities, have a roller which does not rotate, have operators having to work with the contraption whilst in cleaning mode, and a combination-of such. This invention offers a paint roller washing system at low cost, offers hands clean handling, offers flexible liquid spray jetting and paint holder clamping, offers a lightweight practical product, offers simplicity to produce, offers to halt throw away paint rollers & paint roller frames because of the ease of cleaning and non-mess.

### SUMMARY OF THE INVENTION

In view of the foregoing disadvantages of the known types of patented paint roller washers that cover the prior art, on this subject, the present invention provides an improved apparatus ably encompassing all the grand features required for this particular invention

To attain this, the present invention essentially comprises a new and improved apparatus for washing clean, paint roller and nap, by way of a close centered row of fast flowing, high pressure liquid jets being controlled and directed at the optimum position onto the nap of a paint roller thus causing the paint roller to rotate at fast revolutions whereby centrifugal and liquid jet forces imparts a loosening of paint, or the likes, from the nap of the paint roller and then the liquid carries the paint, or the likes away from the apparatus. The invented apparatus, to perform this objective is composed of a plastic or metal containment cylinder, longer than the paint roller and which is sufficient in inside diameter to internally accommodate the paint roller, the paint roller rotation frame and the jet spray pipe. The outside of the containment cylinder does have an adjustable holding bracket which secures the paint roller frame in such a position that the paint roller is perfectly positioned inside the containment cylinder and the paint roller is allowed to freely rotate, (in either direction), on the rotational axis of the paint roller frame. Please note that the paint roller is at all times fixed to the paint roller frame whereby a persons hands need only touch the clean paint roller frame handle. A notch cut into the end of the containment cylinder holds the paint roller frame in a fixed position, in that, both the holding clamp and the notch hold the paint roller frame rod in place until such times as the washing job is completed.

To apply a well-directed and efficient jet spray, a small diameter pipe with many small close centered jet sized holes, acting as fluid jets, along its length is held, just inside the wall of the containment cylinder, by means of a U-clamp fixed near each end of the containment cylinder. One end of the jet spray pipe is plugged with a removable screw, which allows for internal pipe cleaning whilst; the other end has fixed pipe fittings, thus allowing for the attachment of a liquid hose, or the likes. The pipe fitting, as such, is generally at right angles to the small jet pipe and protrudes through a substantial notch cutout at the end of the containment cylinder. The size of this notch is sufficient to allow the spray jet pipe to rotate to a desired arc position, being held in place by both end U-clamps. In so doing it allows for the effective use of the column and row direction of the liquid jets to impart high pressure for swift rotation to the paint roller.

Thus the washing sequence is to attach the liquid pressure hose to the apparatus, clamp on the paint roller frame, with a laden paint roller attached, hold the paint roller frame handle with one hand, or lay the holder on the ground or sink and turn on the liquid pressure. Make adjustments, if necessary, to the jet stream direction relative to the paint roller nap. Allow time to wash clean the paint from the paint roller nap, using the high pressure jet flow and centrifugal force to do there job efficiently. Note that the jet stream can be directed to rotate the paint roller in an opposite direction thus allowing the system to clean more thoroughly by way of the jets attacking the roller fibers from the opposite direction.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited, in its application, to the details of construction and the arrangement of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a clean hands paint roller washer system that will overcome the shortcomings of the prior art paint roller washers.

An object of the present invention is to provide a paint roller washer that will remove the need to have bare or gloved hands to touch the paint roller, if laden with paint.

Another object is to provide a low cost apparatus.

Another object is to provide a convenient lightweight apparatus.

Another object is to provide an apparatus, which offers 360 degrees shrouding of the jet spray splatter, thereby averting a messy situation.

Another object is to provide a paint roller frame clamping system which is adjustable, thus compensating for the variety of paint roller diameters and varied dimensions on paint frame.

Another object is to provide an apparatus, which provides for directional high pressure liquid jet adjustment to allow efficient impingement on to the variety of paint roller diameters and nap densities in proprietary form.

Another object is to provide the means of cleaning out the jet pipe to prevent jet hole clogging.

Another object is to provide a quick means of removing the jet spray pipe, from the apparatus for cleaning purposes.

Another object is to provide the means of having a full range of proprietary paint roller frames, with paint rollers, securely attach to the apparatus.

Another object is to provide the apparatus with a fluid pressure connection fitting consistent with the markets matching fittings.

Another object is to offer the trade a compact unit that can be considered a carry tool.

And yet another object is to allow many different manufacturing methods of this clean hands paint roller washer system whilst maintaining the purpose of the art form. The spray jet method could be different and materials used could be of aluminum, steel, plastic, and the likes, and the shape and style different than shown on the following drawings.

Other objects and advantages of the present invention will become obvious to the reader and is intended these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein.

FIG. 1 is an external isometric view of the present invention.

FIG. 2 is an internal view of components located inside the containment cylinder.

FIG. 3 is an end view of the apparatus.

FIG. 4 is an end view of the apparatus.

FIG. 5 Exploded view of paint roller frame clamping bracket components.

### DETAILED DESCRIPTION OF THE INVENTION

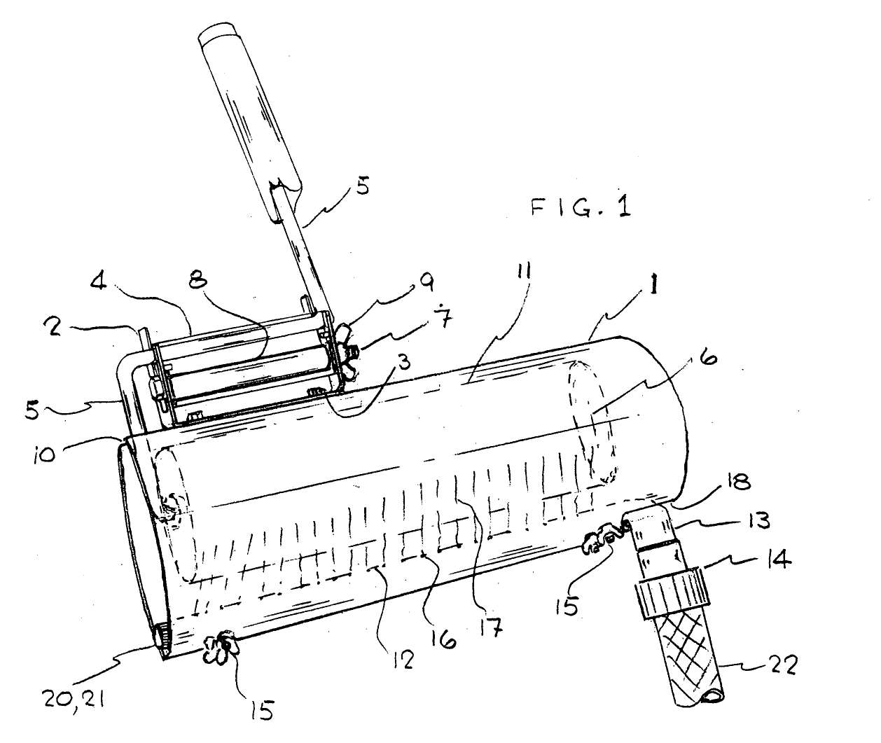

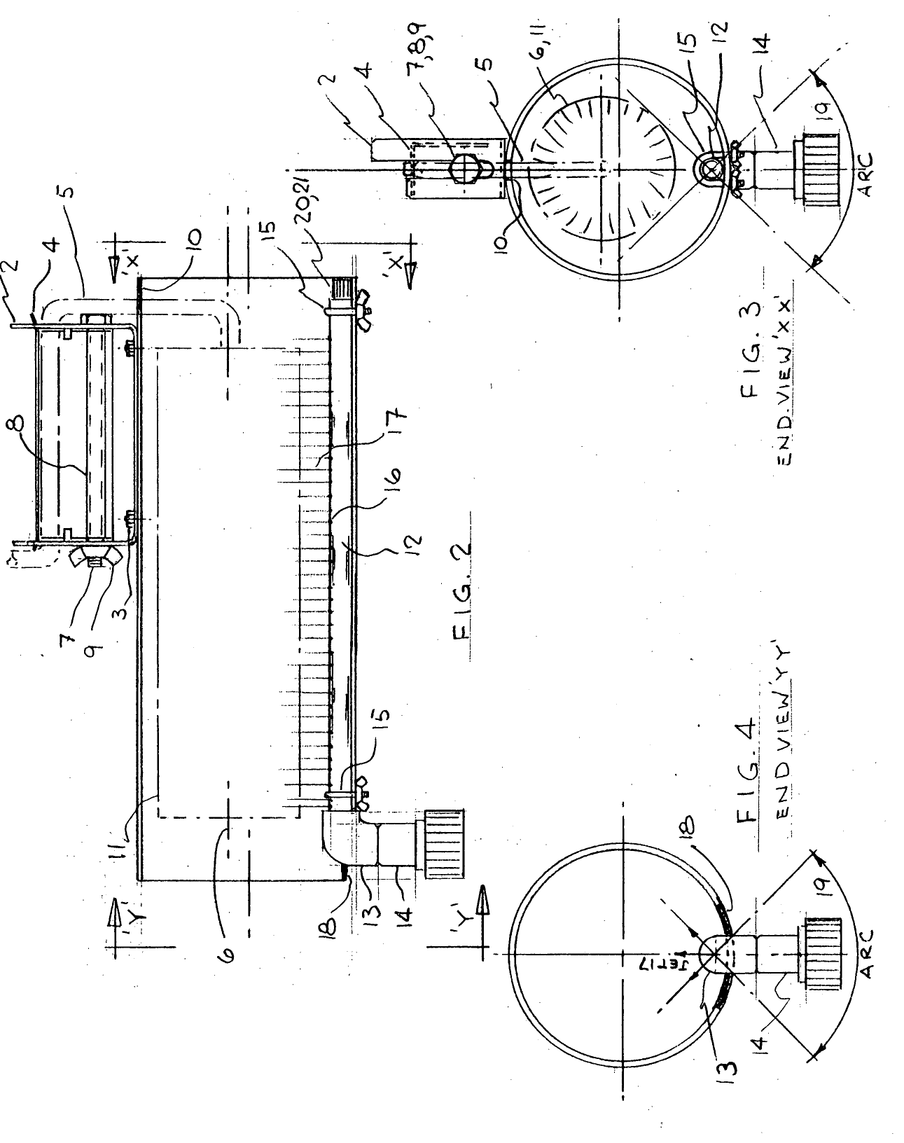

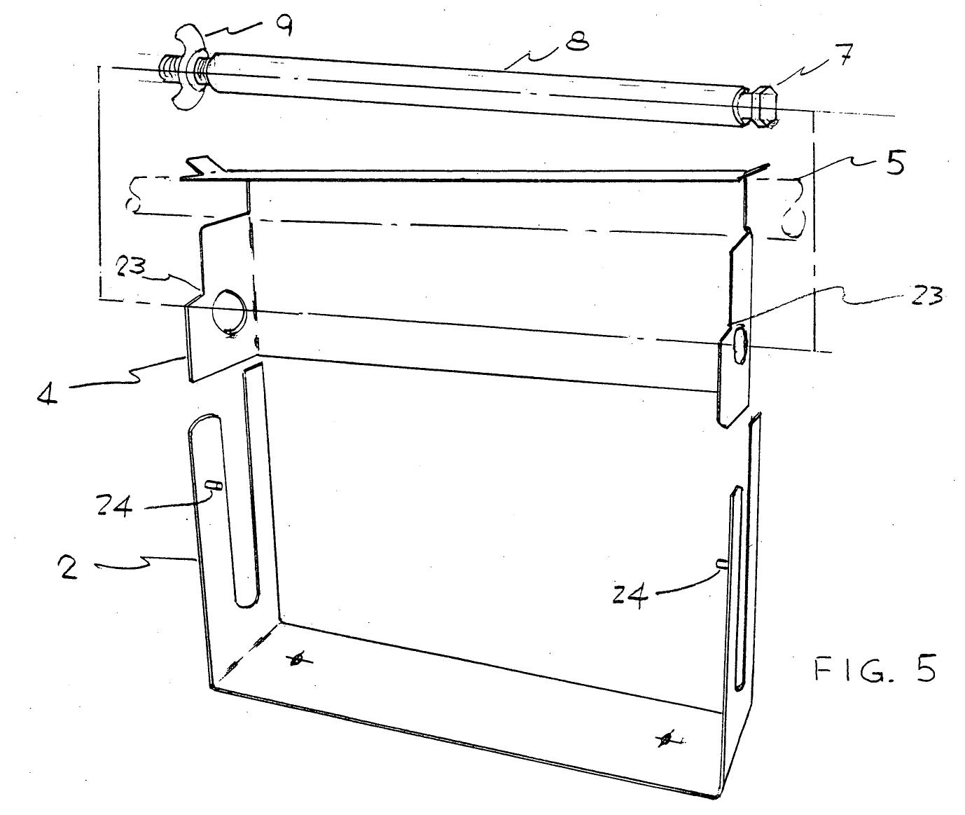

Turning more descriptively to the drawings, in which similar reference characters denote similar elements throughout the several views. The attached FIGS. 1, 2, 3, 4 and 5 illustrates a portable clean hands paint roller washer system, which comprises a containment cylinder (1) and has a slotted U-bracket (2) bolted (3) to the containment cylinder (1). An angled latch bar (4) is made to slide, in and out, inside the U-bracket (2) legs and by lifting the latch bar (4) the paint roller frame (5) can be located above the location slots, in either end of the U-bracket (2). The latch bar (4) along with the paint roller frame (5) is then slid towards the containment cylinder (1) by way of the slots provided on the U-bracket (2). The final clamping position for the latch bar (4) will be determined by the ideal position of the paint roller (6), (11) inside the containment cylinder (1). Clamping of the paint roller frame (5) is by way of a bolt (7) which is threaded through a tube (8) and is used to clamp both sliding contact faces, on both U-bracket (2) and latch bar (4). This is done by way of a wing nut (9). The tube (8), bolt (7) and wing nut (9) act as fasteners to hold the paint roller frame (5) and thus the paint roller (6) itself, in the desired position to commence cleaning. Lateral constraint of the paint roller frame (5) is provided by means of an easy slot (10), located at the bracket end of the containment cylinder (1). Thus the paint roller frame (5) and paint roller (6) is held securely and in the perfect cleaning position to perform the task of removing paint particles from the paint roller nap (11). A notch (23) is made on the latch bar (4) bent ends such that the latch bar cannot slide off the U-bracket (2) in that, a pin stopper (24), attached to each U-bracket (2) leg, will stop its departure.

A small spray jet pipe (12), an elbow (13) and a hose connector (14) are glued together and the assembly (12), 13) and (14) are held in position by two U-clamps (15) which is positioned securely to the containment cylinder (1). The spray jet pipe (12) has close-drilled holes (16), drilled along its length to provide a powerful liquid jet stream (17) and in a controlled direction (19). The spray jet pipe (12) is held securely, in the selected position, by two U-clamps (15). An open slot (18) is provided in the containment cylinder to allow the assembly (12), (13) and (14) to rotate through an arc (19) sufficient to provide the best and most efficient washing angle of the liquid jet stream (17) into the paint roller nap (11). The other end of the spray jet pipe (12) is liquid sealed by means of a screw plug (20) and a ringed seal (21) being screwed into the spray jet pipe (12) end. A liquid hose (22) is affixed to fitting assembly (14), to supply sufficient liquid volume and pressure to adequately rotate and wash the paint roller nap (11).

We claim:

1. A compact portable containment cylinder which is the basic principal to vital additional components, making this contraption solve all problems found with past and present patents comprising claims 1 to 10.

2. A strong, light weight containment cylinder capable of substantial abuse and able to contain the liquid jet splatter within its walls. A bracket system, affixed to the containment cylinder, capable of compensating for the many variations found with this art, such as, paint roller variable diameters, paint roller variable nap materials and lengths Also, the paint roller holder has variable shape dimensions as sold. All these variations are compensated for by the unique bracket design, thus any standard paint roller holder can be used. This bracket will allow the central positioning of the paint roller within the containment cylinder to offer the optimum position for the art of cleaning the paint roller.

3. A fluid jet system is offered to allow maximum paint roller cleaning and is brought about by its ability to offer a close centered small holed, high pressure jet pattern of variable angles of attack on the paint roller nap. This is brought about by positioning and clamping, in that position, a jet stream which will take into account the nap length, density and speed of rotation required. The opposite angle of attack, by means of counter rotation of the roller, will further assist in the thorough cleaning of the nap.

4. A fluid supply system has been allowed for in our claims to offer outside and inside supply to accommodate external and internal cleaning facilities.

5. A system has been devised to allow a person operating the paint roller washer system to be ably to walk away or do something else right after completing the adjustment and water start up.

6. A system has been devised that the operator need not have his or her hands soiled. It is a perfectly clean hands operation.

7. A fluid filter will be incorporated at the entry to the jet pipe, so thereby minimizing clogging of the jet holes.

8. A removable plug affixed to the end of the jet pipe will allow for debris clean out. A holding bracket assembly, according to claim 1, capable of firmly holding the paint roller frame and being capable of positioning the paint roller within the containment cylinder as compensation for the varied sizes found when dealing with proprietary paint rollers and paint roller frames. In combination:
a. A U-bracket having a slot down each side of its legs and having one of its legs longer than the other is bolted, at its base, to the side of the containment cylinder. The position of bolting is such that a basis for the paint roller holder, to be located, is established. So that the paint roller frame can be firmly held, a latch bracket is made to slide, up and down, between the U-bracket legs. This latch bracket is L-shaped so that the leg will engage with the paint roller frame rods top edge. The bottom edge of the paint roller frame rod is retained by the latch bracket whose ends are bent to accomplish the face to face contact with the inside faces of the U-bracket legs. The bottom edge of the rod will rest on the top edge of the latch brackets bent ends, thus the said rod position will be totally controlled by the latch bracket. The rod can only be placed in its cradle from the side and when pushed down is then held laterally by the U-bracket slots. When in this position the rod is held in both directions and cannot escape. The paint roller frame is further constrained by allowing the rod to slide into a slot provided in the end of the containment cylinder and so stabilizing the positioning of the paint roller holder and thus the paint roller. A notch is made on the latch brackets bent ends such that the latch bracket cannot slide off the U-bracket in that a pin stopper, attached to each U-bracket leg, will stop its departure. Now, to clamp in position the U-bracket, latch bracket and paint roller holder, a bolt, tube distance piece and wing nut is designed to sandwich the sliding plates such that they cannot move from the selected ideal roller cleaning position. The bolt is made to slide up and down in the two slots provided on the U-bracket along with the latch bracket. Clamp force is by way of the wing nut thus providing a very stable, easy to operate, easy to control bracket assembly.

9. A high pressure fluid jet system, according to claim 1, capable of directing a number of fluid jets, through small holes within close proximity to each other, aimed at the paint roller nap material, along its length. The jet system is also capable of being directed by rotating the system through an arc which encompasses the largest to the smallest paint roller diameter. The directional jet pattern is also made capable of reversing the rotation direction of the paint roller to allow for thorough cleansing of the nap materials. In combination:
a. A small pipe having close drilled holes, along its length, has also an elbow and liquid hose connector, with filter, affixed to one end whilst at the other is a removable plug used for pipe and jet clean out purposes. This jet pipe assembly is positioned to rest along the inside face of the containment cylinder and is clamped in that position by two U-clamps found at both ends of the containment cylinder. Each U-clamp has two wing nuts used to tighten the jet pipe against the inside face of the containment cylinder. This clamp provides tension but allows rotation movement when directing or re-directing the jet flow towards the most efficient angle for cleaning the nap material.

10. A unique clamp that allows the paint roller flame to be located appropriately and locked into position with a single wing nut.
